(19) United States
(12) Patent Application Publication
(10) Pub. No.: US 2007/0180193 A1
(43) Pub. Date: Aug. 2, 2007

(54) History based line install

(75) Inventors: David S. Hutton, Poughkeepsie, NY (US); Kathryn M. Jackson, Poughkeepsie, NY (US); Keith N. Langston, Woodstock, NY (US); Pak-kin Mak, Poughkeepsie, NY (US); Arthur J. O'Neill JR., Wappingers Falls, NY (US)

Correspondence Address: RICHARD M. GOLDMAN, 371 ELAN VILLAGE LANE, SUITE 208, CA, 95134, US

(73) Assignee: International Business Machines Corporation, Armonk, NY (US)

(21) Appl. No.: 11/342,993

(22) Filed: Jan. 30, 2006

(51) Int. Cl. G06F 12/00

(52) U.S. Cl. 711/122

(57) ABSTRACT

Using local change bit to direct the install state of the data line. A multi-processor system that having a plurality of individual processors where each of the processors has an associated L1 cache, and the multi-processor system has at least one shared main memory, and at least one shared L2 cache. The method described herein involves writing a data line into an L2 cache comprising and a local change bit to direct the install state of the data line.

### BACKGROUND

1. Field of the Invention

The invention relates to memory caching where portions of the data stored in slower main memory are transferred to faster memory between one or more requesting processors and the main memory, especially where a local change bit direct directs selected data from main memory into the cache.

2. Background Art

When data is first reference in a multi-processor system, it is difficult to predict if that data will eventually be changed, for example by a “store” or only “read” by the requesting processor. If data is installed in a “read” state in the cache, and the processor does not “store” the line, extra delay is required to ensure cache coherency. That is, all other copies of the line must be removed from other caches.

On the other had, one may assume that a line will be changed, e.g., via a “store, and install the line “exclusive” to the processor. However, this also causes all other copies of the line to be removed from other caches. Now, if the data was only to be “read” by both processors, that is, shared data, the line would be subject to a “tug of war” between the caches, this reducing performance.

Thus, a clear need exists to obtain the effect of having software direct the hardware with respect to how each line will be used, that is, read only or changed, but without requiring all of the software in the software stack to be modified to indicate how each line will be used.

### SUMMARY OF THE INVENTION

This is obviated by a history-based install where a local change bit is used to direct the install state of a data line. Specifically, when a line of data is referenced from memory the first time, current system implementations install the line “exclusive” in all caches, thereby preparing for eventual stores. The line is not shared with any other processor at this point. So, this represents the most efficient state.

However, once a second processor requests the line, the line appears as “read only” for both processors. This is true whether or not the line is still in use in the first or requesting processor, or whether the first processor is finished with the line and the second processor is now the sole user of the data line.

According to the method described herein, we use the data line's history to determine the state to install this line in the new cache. If the line was changed during its tenure in the first processor's cache, then modeling suggest that the will likely be changed by the new processor. But, if the line was not changed during its tenure in the first processor's cache, then modeling suggests that this line will likely not be changed by this new processor as well.

This is followed for the entire software stack without additional software instructions.

### THE FIGURES

The figures illustrate various embodiments and exemplifications of our invention.

FIG. 1 illustrates a processor and L1 cache, an L2 cache, and main memory.

FIG. 2 illustrates a system including two processors with L1 caches, a shared L2 cache, and main memory.

### DETAILED DESCRIPTION

Described herein is a multi-processor system that has a plurality of individual processors. Each of the processors has an associated L1 cache, and the multi-processor system has at least one shared main memory, and at least one shared L2 cache. The method described herein involves writing a data line into an L2 cache comprising and a local change bit to direct the install state of the data line.

A local change bit is a bit associated with each line stored in any of the caches and maintains local change state information for the particular one of the lines stored in the particular one of the caches. Specifically, the local change bit indicates whether or not the particular one of the lines stored in a particular one of the caches has been modified by any one the processors in the multiprocessor system while resident in the particular cache.

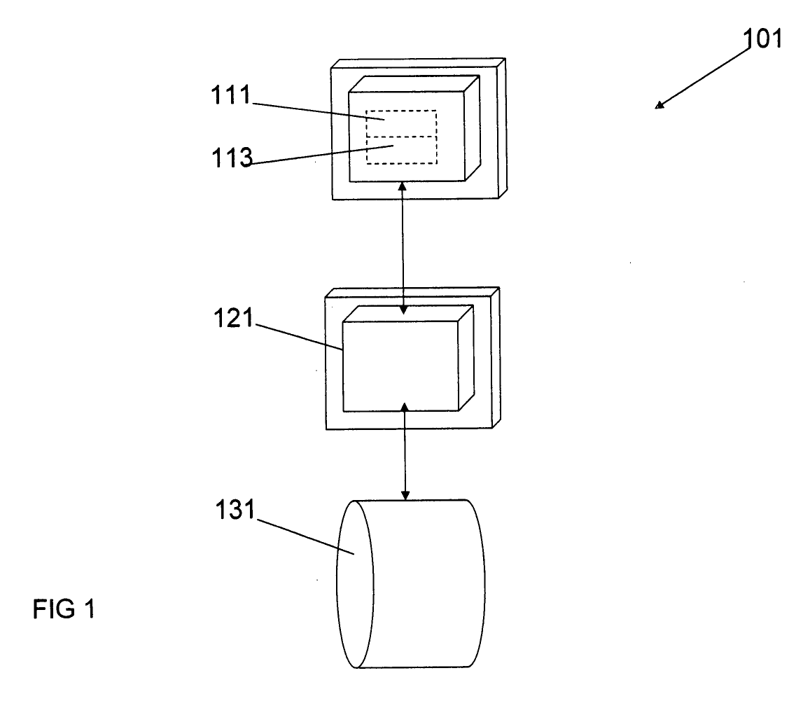

FIG. 1 illustrates a processor system 101 including a processor 111 and L1 cache 113, an L2 cache 121, and main memory 131. The application running on the system takes advantage of this enhancement by fetching data from the cache instead of main memory. Thanks to the shorter access time to the cache, application performance is improved. Of course, there is still traffic between memory and the cache, but it is minimal.

The system 101 first copies the data needed by the processor 111 from main memory 131 into the L2 cache 121, and then from the L2 cache 121 to the L1 cache 113 and into a register (not shown) in the processor 111. Storage of results is in the opposite direction.

First the system copies the data from the processor 111 into the L1 cache 113, and from the L2 cache 121. Depending on the cache architecture details, the data is then immediately copied back to memory 131 (write-through), or deferred (write-back). If an application needs the same data again, data access time is reduced significantly if the data is still in the L1 cache 113 and L2 cache 121 or only the L2 cache 121. To further reduce the cost of memory transfer, more than one element is loaded into cache. The unit of transfer is called a cache block or cache line. Access to a single data element brings an entire line into the cache. The line is guaranteed to contain the element requested.

Latency and bandwidth are two metrics associated with caches and memory. Neither of them is uniform, but is specific to a particular component of the memory hierarchy. The latency is often expressed in processor cycles or in nanoseconds, while bandwidth is usually given in megabytes per second or gigabytes per second.

In practice the latency of a memory component is measured as the time it takes to fetch the first portion of a unit of transfer (typically a cache line). As the speed of a component depends on its relative location in the hierarchy, the latency is not uniform. As a rule of thumb, it is safe to say that latency increases when moving from L1 cache 113 to L2 cache 121 to main memory 131.

Some of the memory components, the L1 cache 113 for example, may be physically located on the processor 111. The advantage is that their speed will scale with the processor clock. It is, therefore, meaningful to express the latency of such components in processor clock cycles, instead of nanoseconds. On some microprocessors, the integrated (on-chip) caches, as L1 cache 113, do not always run at the speed of the processor. They operate at a clock rate that is an integer quotient (½, ⅓, and so forth) of the processor clock.

Cache components external to the processor do not usually, or only partially, benefit from a processor clock upgrade. Their latencies are often given in nanoseconds. Main memory latency is almost always expressed in nanoseconds.

Bandwidth is a measure of the asymptotic speed of a memory component. This number reflects how fast large bulks of data can be moved in and out. Just as with latency, the bandwidth is not uniform. Typically, bandwidth decreases the further one moves away from the processor 111.

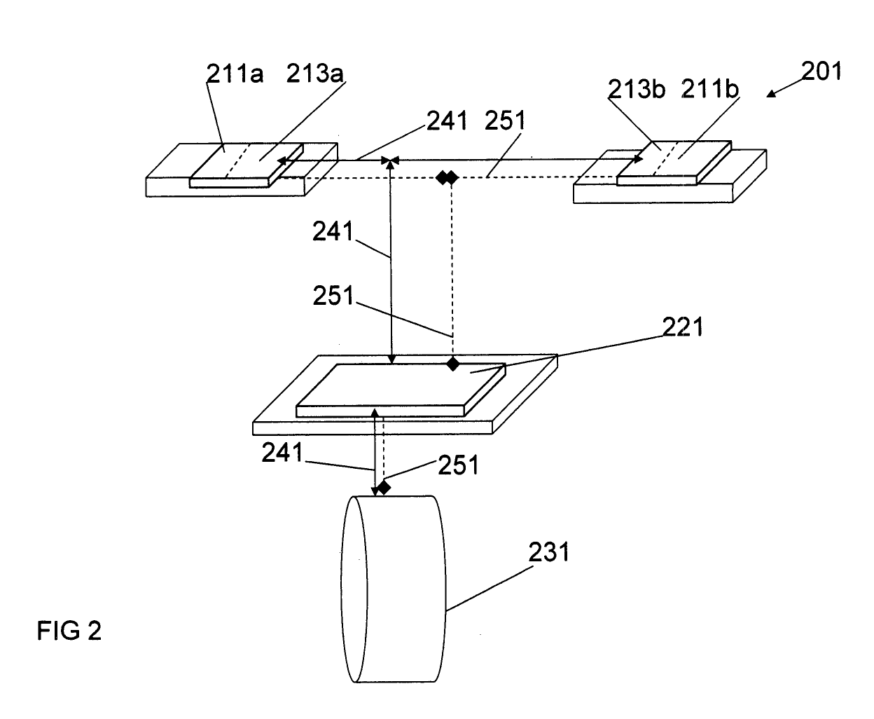

If the number of steps in a data fetch can be reduced, latency is reduced. FIG. 2 illustrates a system 201 including two processors 211a, 211b with L1 caches 213a, 213b, a shared L2 cache 221, and main memory 231. Data lines 241 and control lines 251 perform their normal function. With respect to FIG. 2, when an exclusive line ages out of an L1 cache 213a or 213b, the L1 cache 213a or 213b sends a signal to the L2 cache 221, indicating that the line no longer exists in the L1 cache 213a or 213b. This causes the L2 cache 221 to be updated to indicate that the line is “disowned.” That is, the ownership is changed from the particular processor to “unowned”.

Looking at FIG. 2, this improves performance by reducing and in some cases even eliminating cross interrogate processing. Eliminating cross interrogate processing avoids sending a cross interrogate to an L1 cache 213a or 213b for a line that, due to L1 replacement or age out replacement no longer exists in the L1 cache 213aor 213b. This results in a shorter latency then when another processor requests the line, and avoids a fruitless directory lookup at the other L1 cache.

Additionally, eliminating cross interrogate processing avoids sending a cross invalidate to an L1 cache 213a or 213b for a line that is to be replaced in the L2 cache 221. Ordinarily, when a line ages out of L2 cache 221, that line must also be invalidated in the L1 cache 213a or 213b. This maintains a subset rule between L1 213a or 213b and L2 221 caches.

These two invalidates disrupt normal processing at the L1 cache 213a or 213b. If the line no longer exists in the L1 cache 213a or 213b, this disruption is unnecessary and negatively impacts performance.

According to the method described herein, we use the data line's history to determine the state to install this line in the new cache. That is, the local change bit is used to direct the install state of a data line. If the line was changed during its tenure in the first processor's cache, then modeling suggest that the will likely be changed by the new processor. But, if the line was not changed during its tenure in the first processor's cache, then modeling suggests that this line will likely not be changed by this new processor as well.

This is followed for the entire software stack without additional software instructions. Initially, all stores set a “locally changed” bit in the cache directory entry. This is in addition to the global change bit which exists for all cache data lines. The global change bit indicates memory needs to be eventually refreshed with all accumulated changes.

If a data fetch misses the local processor data cache, but hits in another cache and the local change bit is enabled in the other cache, the line is removed from the other processor cache and installed “exclusive” to the new processor. In addition, the local change bit is reset (off) in the new cache. This is in contradistinction to earlier practice, where it would have been installed “read only to multiple processors”.

If a data fetch misses the local processor data cache, but hits in another cache and the local change bit is “off”, the line is installed “read only” to the new processor and both cache states are set to indicate the existence of multiple copies of this line installed in the system. The local change bit is set “off” in both caches.

In this way the local change bit is used to direct the install state of a data line.

While the invention has been described with respect to certain preferred embodiments and exemplifications, it is not intended to limit the scope of the invention thereby, but solely by the claims appended hereto.

We claim:

1. In a multi-processor system having a plurality of individual processors, each of said processors having an associated L1 cache, said multiprocessor system having at least one shared main memory, and at least one shared L2 cache, a method of writing a data line into an L2 cache comprising using a local change bit to direct the install state of the data line.

2. The method of claim 1 wherein a data line's history determines the state to install the line in cache, comprising: referencing a line of data from main memory a first time; and causing the line to appear as “read only” when a second processor requests the line.

3. The method of claim 1 comprising initially setting all stores to “locally changed” cache directory entry.

4. The method of claim 1 wherein when a local processor data fetch misses a local processor data L1 cache in a first L1 cache, but hits in a second L1 cache, enabling the local change bit in the second L1 cache, removing the line from the second processor L1 cache and installing an “exclusive” to the second processor.

5. The method of claim 4 comprising resetting the local change bit to “off” in the second cache.

6. The method of claim 1 wherein when a data fetch misses the local processor L1 data cache, and hits in another processor L1 cache where the local change bit is “off”, installing the line “read only” to the new processor and setting both cache states to indicate the existence of multiple copies of this line installed in the system.

7. The method of claim 6 comprising changing the local change bit “off” in both caches.
